(19) United States
(12) Patent Application Publication
(10) Pub. No.: US 2017/0316671 A1
(43) Pub. Date: Nov. 2, 2017

(54) EXTENSION CABLE FOR A MEDICAL SENSOR AND DATA NETWORK DEVICE

(71) Applicant: Drägerwerk AG & Co. KGaA, Lubeck (DE)

(72) Inventor: Thomas GRASSL, Lübeck (DE)

(21) Appl. No.: 15/582,882

(22) Filed: May 1, 2017

(30) Foreign Application Priority Data
May 2, 2016 (DE) 10 2016 005 324.0

(51) Int. Cl. G08B 21/04; G08B 25/08

(52) U.S. Cl. CPC G08B 21/0453; G08B 25/08

(57) ABSTRACT

A medical sensor extension cable includes a sensor electrical contacting interface, that receives an electrical sensor signal which indicates a physiological parameter of a patient, and a wired data interface, that connects to a data network device. An integrated circuit determines measured values of the physiological parameter based on the sensor signal, to provide an alarm limit value, to establish a presence of an alarm event as a function of a comparison of the measured values and the at least one alarm limit value, as well as to provide data elements, which indicate the measured values and the presence of the alarm event in the event of an alarm, via the data interface. A data network device includes a data connection interface for a data interface of the extension cable. A display interface provides a display signal, which indicates the measured values and the alarm limits.

### CROSS REFERENCE TO RELATED APPLICATIONS

This application claims the benefit of priority under 35 U.S.C. §119 of German Application 10 2016 005 324.0 filed May 2, 2016, the entire contents of which are incorporated herein by reference.

### FIELD OF THE INVENTION

Medical sensors, which provide an analog electrical signal, which in turn indicates a physiological parameter of a patient, are known from the state of the art. Such a medical sensor may be, for example, a sensor for an oxygen saturation measurement, wherein precisely the electrical sensor signal then indicates oxygen saturation values of the patient.

### BACKGROUND OF THE INVENTION

Such medical sensors are preferably connected to a so-called patient monitor or a display device via an electrical sensor cable corresponding to the sensor by means of an electrical contacting area or plug located at the end of the sensor cable. The connection to a patient monitor takes place directly or indirectly via an adapter. Such a patient monitor receives the analog electrical sensor signal, generates measured values herefrom and displays these measured values on a display unit of the monitor for a clinician. Such a patient monitor preferably also has a functionality, in which the measured values are compared with limit values which can be input or can be configured at the monitor in order to then output an alarm signal in the event of exceeding a limit value.

Such a patient monitor described above preferably has a plurality of connection points for respective, different sensors in order to monitor a plurality of physiological parameters of the patient. The patient monitor is usually located in the immediate vicinity of the patient or of the patient bed for the output of information and alarms.

### SUMMARY OF THE INVENTION

An object of the present invention is to advantageously provide an analysis of a sensor signal of a medical sensor for a possible alarm event.

According to the invention, an extension cable is provided for a medical sensor. The medical sensor extension cable comprises an electrical contacting interface for connection to the medical sensor and for receiving an electrical sensor signal, which indicates a physiological parameter of a patient. The medical sensor extension cable further comprises an integrated circuit for processing the sensor signal, as well as a wired data interface for direct or indirect connection to a data network device, wherein the integrated circuit is configured to determine measured values of the physiological parameter based on the sensor signal, further to provide at least one alarm limit value in relation to the physiological parameter, further to establish the presence of an alarm event as a function of a comparison of the measured values and the at least one alarm limit value, as well as further to provide one or more data elements, which indicate the measured values and the presence of the alarm event in the event of an alarm via the data interface. A direct connection is given, for example, if the wired data interface is directly connected to a connection interface of the data network device, i.e., e.g., an RJ-45 port of the IP router. An indirect connection is given, for example, if the wired data interface is first connected to an RJ-45 socket in a patient room and this RJ-45 socket then in turn establishes a wired connection to an RJ-45 port of an IP router.

The following explanations can be taken into consideration for obtaining the advantages achieved by the extension cable according to the present invention. According to the concept from the state of the art, a medical sensor provides only an electrical sensor signal, which is then analyzed directly—or indirectly via an adapter—in a patient monitor in regard to alarm limits stored in the patient monitor in order to detect an alarm event. The extension cable according to the present invention deviates from this in its basic concept. Because an integrated circuit, which can already itself provide an alarm limit value, preferably by means of a memory unit provided in the integrated circuit, is provided in the extension cable, the measured values derived from the electrical sensor signal in regard to an alarm event can be analyzed directly in the cable or the integrated circuit thereof. By providing the one data element or the plurality of data elements, which indicate both the measured values and the presence of the alarm event in the event of an alarm, a data network device, which is connected to the wired data interface of the extension cable, can use these data in a network device that can be reached by means of the data network device without having to check for the presence of the alarm event itself. Hence, a concept is made possible according to the present invention, in which the extension cable itself establishes the alarm event by means of the alarm limit values stored in the integrated circuit. Because, for example, the alarm limit values in the integrated circuit are configurable, the data network device or network device does not itself have to be configured in regard to the alarm limit values or the detection of the alarm event. Thus, the data network device, despite not itself carrying out a detection of an alarm event, nevertheless can display an alarm event or output a corresponding warning to the user. In this case, the data network device can also display the measured values itself.

The data network device itself may be a data transmission device in the sense of an IP router or an Ethernet switch, which then forwards the data elements within a data network. As a result, it is thus made possible according to the present invention that the data elements for output or an alarm provided by the extension cable at the data interface do not have to be analyzed directly at such a location, at which a sensor cable is connected to a device, e.g., a patient monitor, but rather that the data elements can preferably also be used in a different area or a different space for an output and/or alarm, without having to carry out the detection of the alarm event there. However, it is not ruled out here that a network-compatible patient monitor or a network-compatible display unit, e.g., a network-compatible display, which in turn receives the measured values and also the indication of the alarm event from the network by means of the transmitted data elements and executes an output and/or alarm, is located in the vicinity of the patient. This patient monitor only has to have one network functionality for this in order to execute the output and/or alarm as a function of the data element received.

Furthermore, it is possible due to the configuration of the extension cable according to the present invention that a plurality of respective extension cables for respective, different medical sensors are positioned in the vicinity of a patient, wherein precisely these extension cables simply then only have to be directly or indirectly connected via the respective wired data interfaces to a data network device, for example, a hub, an IP router or an Ethernet switch in order to transmit different sensor data or sensor measured values and corresponding alarm indications into a network. Instead of using different patient monitors for different sensors or different physiological parameters, it is thus now possible to provide the corresponding different measured values and the alarm indications in a compact manner via the respective wired data interfaces, for example, LAN (local area network) plugs or USB (universal serial bus) plugs, which saves space for the area of the patient or for the patient care area.

It can then be decided by the data network device itself which of the measured values and alarm indications shall be transmitted with a network to which medical device.

Such flexible concepts for analyzing or providing and transmitting measured values and data elements, which contain alarm indications, provided from sensor signals, are not known from the state of the art.

The extension cable according to the present invention is preferably characterized in that the data elements further indicate the at least one alarm limit value. Due to this configuration of the present invention, it is ensured that a network device, which also receives the alarm limit value, can display same together with the measured value data.

The extension cable according to the present invention is preferably characterized in that the data elements further indicate a degree of priority in relation to a prioritized transmission of the data elements in a data network. Due to this configuration of the present invention, it is ensured that certain data elements with certain measured values and certain alarm indications can be transmitted with higher priority and more rapidly in the network than other data elements, the measured values and alarm indications of which have a lower priority. As a result, it is thus ensured that especially important measured values and alarm indications are transmitted by priority and more rapidly through the network to corresponding network devices.

The extension cable according to the present invention is preferably characterized in that the data elements further indicate a physiological property corresponding to the measured values. As a result, it is ensured that a network device, which would like to obtain knowledge as to which physiological property the transmitted measured value data of the data element belongs, such knowledge can be derived from the data elements themselves.

The extension cable according to the present invention is preferably characterized in that the data elements further indicate at least one time value associated with the measured values. As a result, it is ensured that a network device, which receives the data elements, can carry out a correlation of the measured values with the time values in order to be able to possibly derive an up-to-date status of the measured values herefrom.

The extension cable according to the present invention is preferably characterized in that the data interface is an optical data interface. The extension cable according to the present invention is further preferably characterized in that the data elements are provided in the form of an optical data signal. As a result, it is ensured that the data transmission is more insensitive to electromagnetic disturbances than in case of a purely electrical signal transmission.

The data interface is preferably configured to receive a supply voltage via electrical contacts, wherein the extension cable further has one or more electrical lines from the electrical contacts to the integrated circuit in order to provide the supply voltage to the integrated circuit.

The extension cable according to the present invention is further preferably characterized in that the integrated circuit is configured to receive optical energy via the optical data interface. As a result, it is ensured that the integrated circuit does not itself have to have an energy source, but rather can be supplied with energy via the optical data interface by means of the optical energy or by means of an optical signal.

The extension cable according to the present invention is further preferably characterized in that the integrated circuit is configured to store patient identification data, and in that the data elements indicate the patient identification data. As a result, it is ensured that a network device, which receives the data elements, can directly associate the measured values and indicated alarms with a certain patient.

The extension cable according to the present invention is further preferably characterized in that the data elements contain redundant data of an error-correcting code, which make possible an error correction of data of the data elements. As a result, it is ensured that a distortion of some of the data elements possibly occurring in the course of the data transmission can be counteracted.

The extension cable according to the present invention is further preferably characterized in that the data elements are provided in an encrypted form. As a result, it is ensured that the data elements cannot be read by unauthorized third communication partners of the data network.

The extension cable according to the present invention is further preferably characterized in that the integrated circuit is configured to store sensor identification data, which indicate a model of the medical sensor, and that the data elements indicate the sensor identification data. As a result, it is ensured that a network device, which receives the data elements, can infer directly from the data elements the model of the medical sensor that was used for deriving the measured values.

The extension cable according to the present invention is further preferably characterized in that the data network device is a data router or a USB hub. This is advantageous because a communication to an expanded data network is made possible by such a data network device.

A data network device, comprising a data connection interface for connection for a data interface of an extension cable according to the present invention, is further proposed, wherein the data connection interface is configured to receive the one data element or the plurality of data elements by means of the data signal, wherein the data network device further comprises a display interface and is configured to provide a display signal, which indicates the measured values and the alarm limits. The data network device according to the present invention is advantageous because a separate patient monitor is not needed to output measured values or alarm indications, but rather a simple display unit, which can be connected directly to the data network device, can be accessed.

A data network device, comprising a data connection interface for connection for a data interface of an extension cable according to the present invention is further proposed, wherein the data connection interface is configured to receive the one data element or the plurality of data elements by means of the data signal, wherein the data network device comprises an additional data interface and wherein the data network device is configured to transmit the data elements as a function of the degree of priority via the additional data interface by means of an additional data signal. This data network device is advantageous because the data elements are transmitted from the data connection interface of the extension cable or the data interface of the extension cable to the additional data interface and thus into the data network as a function of priority data indicated in the data elements.

The data network device is further characterized in that the additional data interface is an interface for the direct or indirect connection of a patient monitor. An indirect connection takes place via a cable and/or an adapter. This configuration of the present invention is advantageous because such a patient monitor with network functionality can use the data elements directly for displaying the measured values and for indicating the alarm event.

The data network device is further characterized in that the additional data interface is a first additional data interface, wherein the data network device further comprises a second additional data interface, and wherein the data network device is configured to transmit the data elements via the second additional data interface with a priority lower than via the first additional data interface by means of a second additional data signal. This configuration of the data network device is advantageous because, as a result, not only are the data elements outputted via the first additional data interface to the patient monitor, but also the data elements are transmitted into the network via the second additional data interface, so that the data elements are quasi copied to be able to be used or displayed by a variety of devices.

The present invention is explained in greater detail below based on special embodiments without limitation of the general idea of the invention based on the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of an extension cable according to the present invention;

FIG. 2 is a graph showing measured values together with alarm limit values;

FIG. 3a is a view showing a data element in a first embodiment;

FIG. 3b is a view showing a data element in a second embodiment;

FIG. 4 is a schematic view of a preferred embodiment of a data network device; and

FIG. 5 is a schematic view of a preferred embodiment of the extension cable according to the present invention.

### DESCRIPTION OF THE PREFERRED EMBODIMENTS

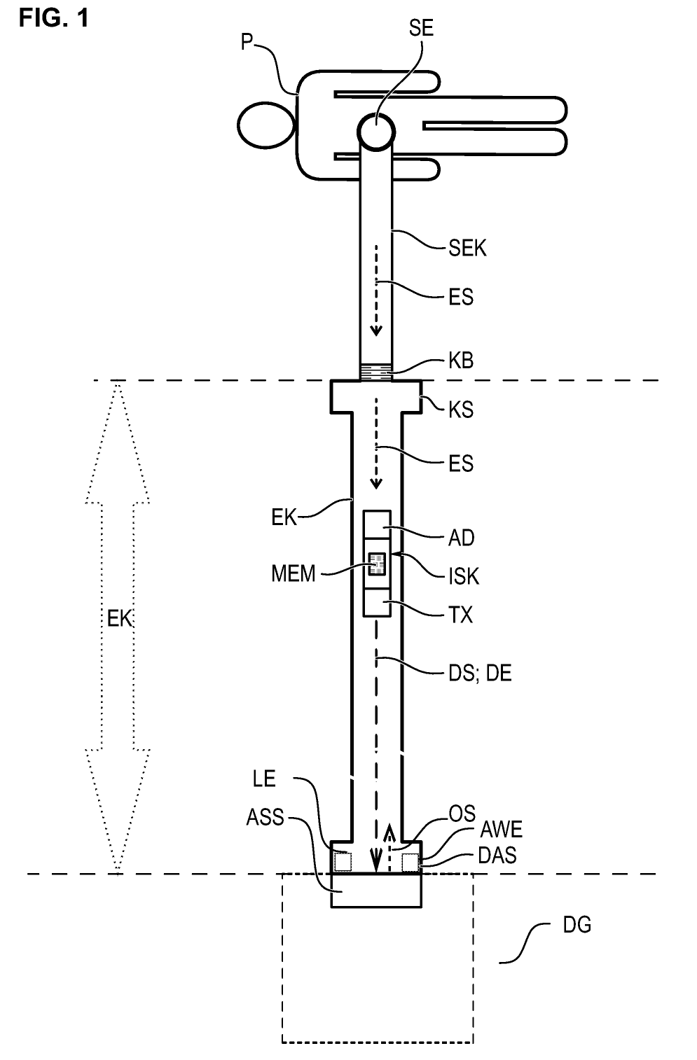

Referring to the drawings, FIG. 1 shows a patient P, to which a sensor SE is attached, in order to detect physiological parameters of a patient. Such a sensor SE is, for example, a sensor for detecting a physiological parameter, such as an oxygen saturation value.

Other physiological parameters are preferably EKG values, an invasive or non-invasive blood pressure, a body temperature, a glucose level, a CO₂ value or an O₂ value. The sensor SE provides an electrical sensor signal ES, which can be an analog or digital signal.

The sensor SE is preferably connected indirectly to an electrical contacting interface KS of an extension cable EK via a sensor cable SEK and a contacting area KB located at the end of the sensor cable SEK. The sensor cable SEK does not absolutely have to be present because it is also possible that the sensor SE itself directly has its own contacting area KB for connection to the contacting interface KS of the extension cable EK.

In case the electrical sensor signal ES is an analog signal, the analog electrical signal ES is digitized in the extension cable EK, as will be explained more precisely later.

In case the electrical signal is a digital electrical signal, a process is present in the sensor SE, which derives digital signals from analog signals received by the sensor SE, which digital signals then indicate measured values of the physiological parameter of the patient P.

The electrical contacting interface KS of the extension cable EK is thus configured for direct or indirect connection to the medical sensor SE.

The electrical contacting interface KS is further configured for receiving the electrical sensor signal ES.

In case the electrical sensor signal ES is an analog signal, an integrated circuit IS has a converter interface AD, for example, an analog/digital converter, in order to derive measured values in relation to the physiological parameter of the patient from the analog electrical sensor signal ES.

The integrated circuit ISK is preferably an Application-Specific Integrated Circuit (ASIC) or a Field-Programmable Gate Array (FPGA).

In case the electrical sensor signal ES is already a digital electrical signal, the circuit ISK receives the electrical sensor signal ES as a digital signal and derives measured values in relation to the physiological parameters of the patient P herefrom. This deriving may be, for example, a 1:1 copy of the values or data indicated by the sensor signal or else a recoding of data, which are indicated by the digital electrical sensor signal ES. The integrated circuit ISK thus processes the sensor signal ES.

The extension cable EK further comprises a wired data interface DAS, which is configured for direct or indirect connection to a data network device DG. A direct connection is a connection of the data interface DAS to a corresponding interface (ASS) of the data network device DG. An indirect connection is a connection of the data interface DAS to the corresponding interface ASS of the data network device DG by means of an additional cable and/or an adapter.

An arrow in FIG. 1 indicates the functional circuit that the extension cable EK comprises.

As explained above, the integrated circuit ISK determines measured values of the physiological parameter based on the sensor signal ES.

The circuit ISK further provides at least one alarm limit value in relation to the physiological parameter. For this, the circuit ISK preferably has an integrated memory unit MEM, in which the at least one alarm limit value is stored. The memory unit MEM of the integrated circuit ISK can preferably be configured, so that the alarm limit values or the alarm limit value do not have to be fixed, but rather can be changed by means of a configuration interface, not shown, or stored in the memory unit MEM.

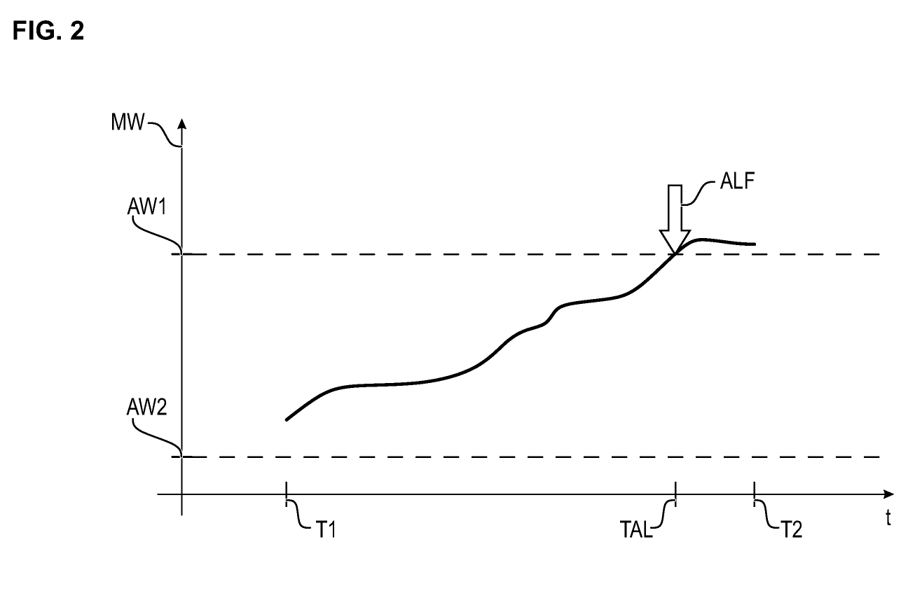

FIG. 2 shows a time curve of measured values MW over the time T together with an upper alarm limit value AW1. Further, a lower alarm limit value AW2 is also shown. In case the measured values MW exceed the upper alarm limit value AW1, the presence of an alarm event ALF at the time TAL is inferred. Thus, the presence of the alarm event ALF is inferred or this is established as a function of a comparison of the measured values MW and of the at least one alarm limit value AW1.

Additional time values T1, T2, which indicate the time, which corresponds to the detection of the measured values MW, are further shown.

Coming back to FIG. 1, it can be ascertained that the integrated circuit ISK provides a data signal DS or one or more data elements DE by means of a data signal DS via a data interface DAS for connection to the data network device DG.

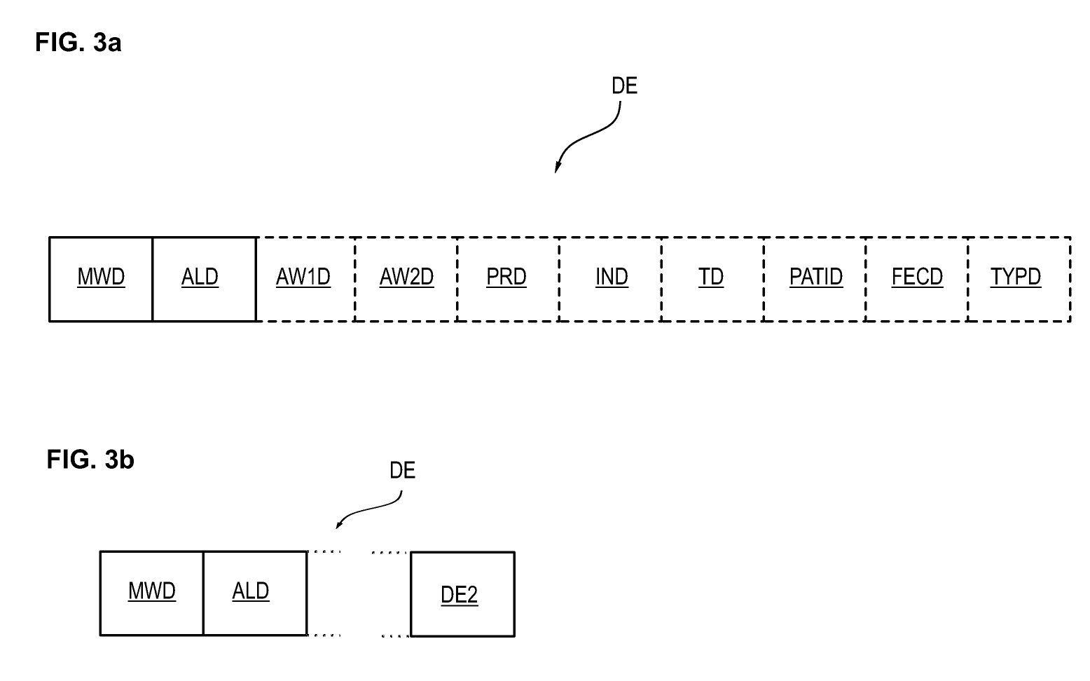

An exemplary data element DE is shown in FIG. 3a. It is clear to the person skilled in the art that the data element DE may also be provided by a plurality of data elements.

The data element DE contains measured value data MWD, which indicate the above-mentioned measured values. Further, the data element DE contains alarm data ALD, which indicate the presence of an alarm event in the event of an alarm. The alarm data ALD are, for example, a bit, which is set to the value 1 in the event of an alarm, and set to the value 0 in case of no alarm event. The alarm data ALD are preferably given as a bit word containing a plurality of bits.

The data element DE preferably contains the at least one alarm limit value AW1D as well as preferably also the alarm limit value AW2D.

The above-mentioned integrated circuit selects a degree of priority for transmitting the data elements as a function of the presence of the alarm event. If the alarm event is present, then a higher degree of priority is selected by the circuit ISK than in case of the absence of the alarm event. The corresponding values of a high or a low priority for the degree of priority are preferably stored in the memory unit MEM from FIG. 1 and can be configured there also preferably via the above-mentioned configuration interface, which is not shown in greater detail.

The data element DE preferably contains degree of priority data PRD, which indicate the degree of priority in relation to the prioritized transmission of the data element DE in a data network.

The data element DE preferably contains a partial data element IND, which indicates the physiological property, which corresponds to the measured values.

The data element DE preferably contains partial data TD, which indicate time values, for example, the time values T1, T2, TAL from FIG. 2 associated with the measured values and the measured value data MWD, respectively.

The data element DE preferably contains patient identification data PATID, which the integrated circuit preferably stores in the memory unit MEM of FIG. 1. As a result, the measured values MWD and the other data shown in the data element DE of FIG. 3a can thus be associated with a patient.

The extension cable EK preferably has a colored, optical lighting element LE, preferably in the form of a light emitting diode (LED), at a point, preferably at the data interface DAS. The circuit ISK controls the lighting element LE such that the lighting element changes color as a function of states detected by the circuit IKS.

If the circuit detects a valid network connection via the data interface DAS, but there are still no patient identification data PATID, then the lighting element LE is yellow. If the circuit detects a valid network connection via the data interface DAS, valid patient identification data PATID are present and data are transmitted to the data interface DAS, then the lighting element LE is green. If an alarm event is present, then the lighting element LE is red, preferably flashing red.

The extension cable EK preferably has an acoustic output unit AWE for the output of an acoustic warning signal as a function of a control signal of the circuit IKS at a point, preferably at the data interface DAS.

The data element DE preferably contains redundant data FECD, for example, Forward Error Correction (FEC) data, which make possible an error correction of data of the data element DE after receiving the data element DE. Such redundant data are, for example, parity check bits, data of a turbo code or of a Reed Solomon code.

The data element DE is preferably provided and transmitted as an encrypted data element DE.

The data element DE further preferably contains sensor identification data TYPD, which indicate the model of the medical sensor, from which the measured values MWD and measured value data were derived.

Coming back to FIG. 1, it can be ascertained that the data network device DG is preferably a data router or a USB hub.

The data interface DAS is preferably an optical data interface, in which the data elements DE are provided in the form of an optical data signal DS.

The integrated circuit ISK is preferably configured to receive optical energy in the form of an optical signal OS via the optical data interface DAS in order to be supplied with energy.

The integrated circuit preferably has a transmitting unit TX for providing the data signal DS and the data elements DE. The transmitting unit TX preferably also comprises a receiving functionality, via which the integrated circuit and the memory unit MEM can be configured.

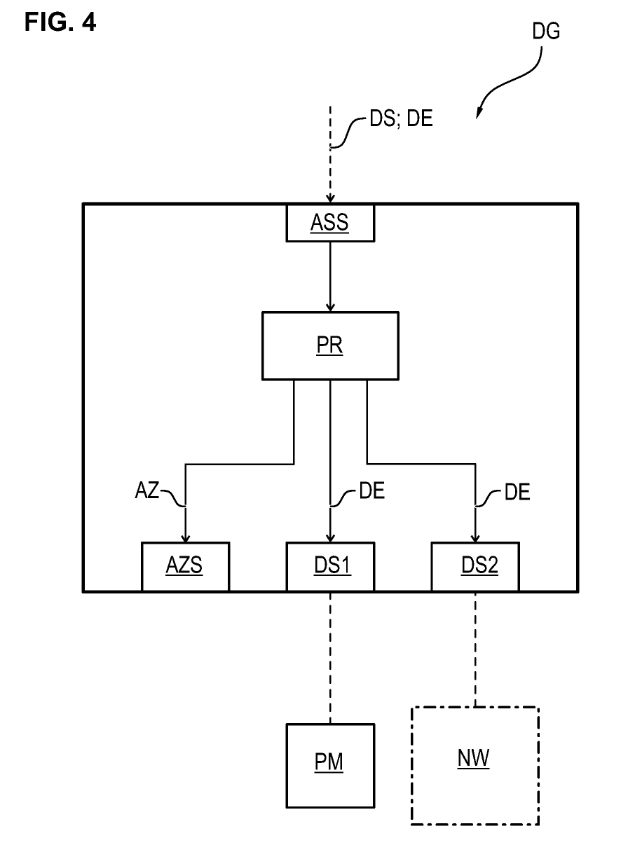

FIG. 4 shows a preferred embodiment of a data network device DG.

The one data element or plurality of data elements DE in the form of the data signal DS is received via a connection interface or a data connection interface ASS for a connection of a data interface of an extension cable from FIG. 1.

The data network device DG has at least one processor unit PR, which controls a processing or forwarding of the data elements DE.

According to a preferred embodiment, the data network device DG further has a display interface or a display interface AZS, via which the data network device DG provides a display signal AZ, which indicates the measured values and the alarm limits. As a result, it is thus made possible that a display unit can be connected directly to the data network device by means of the display interface AZS in order to output the measured values and also an alarm warning.

The data network device DG preferably has an additional data interface DS1, via which the processor PR of the data network device DG transmits the data elements DE as a function of the indicated degree of priority via the data interface DS1. This transmission can then take place from the interface DS1 to a patient monitor PM. The patient monitor is preferably an integral component of the data network device DG.

In addition to the additional data interface DS1, the data network device DG preferably has a second additional data interface DS2, wherein the data network device DG transmits the data elements DE by means of a processor PR via the second additional data interface DS2 with a priority lower than via the first additional data interface DS1. The interface DS2 is preferably a network interface to a data network NW. The second additional data interface DS2 is a data network interface.

As a result, it is ensured that the data elements DE that possibly contain critical data are transmitted to the patient monitor PM in a timely manner, which may be of special importance for a clinician, while the transmission of the data elements DE via the network interface DS2 to the network NW can be carried out with lower priority, because, for example, only a storage or recording of the data elements and of the individual data contained therein is carried out as an uncritical application within the network.

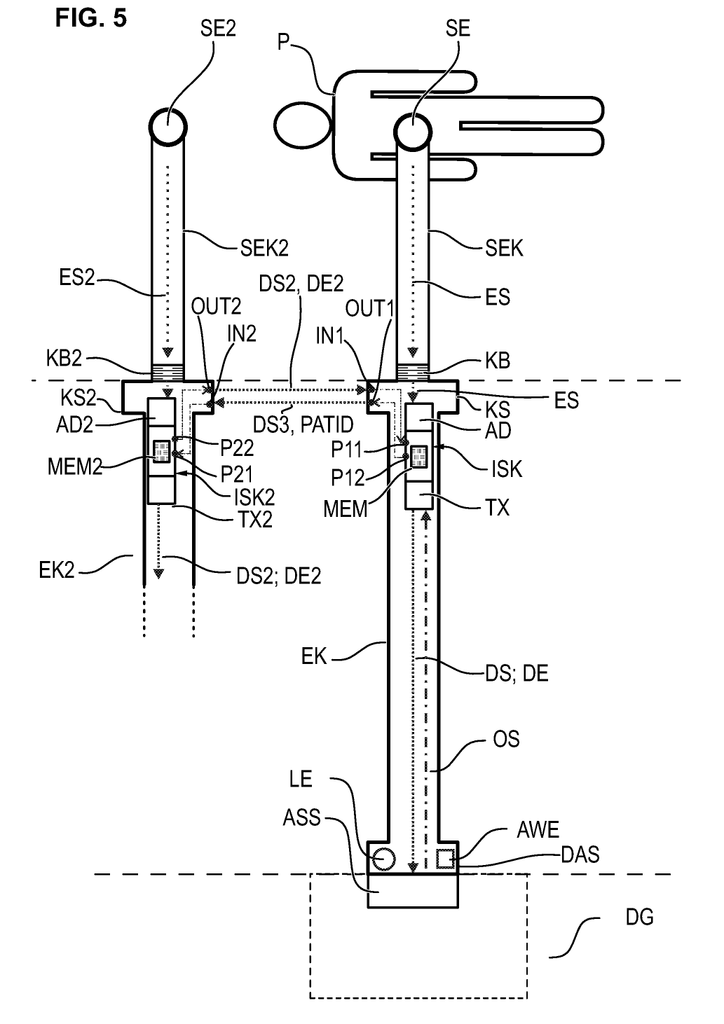

FIG. 5 shows a preferred embodiment of the extension cable EK. The integrated circuit ISK is preferably located in this case in the area of the contacting interface KS.

The extension cable EK further has a data input interface IN1 as well as a data output interface OUT1. These interfaces IN1, OUT1 are preferably located in the area of the contacting interface KS. The interfaces IN1, OUT1 are preferably electrical contacting interfaces.

The interface IN1 is connected to a circuit interface P11 for receiving data by the circuit ISK. The interface OUT1 is connected to a circuit interface P12 for outputting data by the circuit ISK. The circuit ISK thus has circuit interfaces P11, P12 for outputting and for receiving data and corresponding data signals, respectively.

FIG. 5 further shows an additional sensor SE2, which provides an additional electrical signal ES2 via its own sensor cable over the contacting area KB2 at an additional extension cable EK2. The additional extension cable EK2 is essentially configured as the extension cable EK already described.

According to FIG. 2, the additional sensor SE2 is not shown explicitly as positioned at the patient P; however, it is obvious to the person skilled in the art that the sensor SE2 can be positioned at the body, in the body or in the vicinity of the patient P in order to provide corresponding sensor values or a corresponding sensor signal ES2. Such sensor values may be an EKG signal, a temperature signal, an air volume flow signal, air pressure signal or else, for example, a signal, which indicates an oxygen saturation value.

It is now possible that the circuit ISK2 of the extension cable EK2 carries out an analysis of the sensor signal ES2 for obtaining a data signal DS2 or a corresponding data element DE2, as described above in relation to the circuit ISK of the extension cable EK as well as the data signal DS and the data element DE.

The circuit ISK2 has circuit interfaces P21, P22, which are in connection with a corresponding data output interface or data input interface OUT2, IN2.

The interfaces IN2, OUT2 are preferably electrical contacting interfaces.

The circuit ISK of the extension cable EK provides a data signal DS2, which indicates or contains the patient identification data PATID, by means of its circuit interface P12 and thus indirectly at the output interface OUT1. These patient identification data PATID and this data signal DS3 are then received by the circuit ISK2 by means of a contacting of the interfaces OUT1 and IN2. This contacting is preferably an electrical contacting.

As a result, it is made possible that the circuit ISK2 uses patient identification data PATID, which are provided by the circuit ISK of the extension cable EK. As a result, it becomes obsolete that a higher network entity or a different administrative entity must provide patient identification data PATID to the circuit ISK2; hence this [circuit] includes such patient identification data PATID in a data element DE2. The circuit ISK2 can thus use patient identification data PATID received by means of the interfaces IN2, P21.

A data element DE2 provided by the circuit ISK2 is configured analogously to the data element DE of FIG. 3a.

The data signal DS2 or data element DE2 generated or provided by the circuit ISK2 is provided by the circuit ISK2 by means of its circuit interface P22 and thus indirectly at the data output interface OUT2. By means of a contacting, preferably an electrical contacting, of the output interface OUT2 with the input interface IN1, the data signal DS2 or the data element DE2 can thus be provided to the circuit ISK of the extension cable EK.

The circuit ISK is then preferably configured, as shown in FIG. 3b, to include the data element DE2 in the data element DE, in order to provide the data element DE2 by means of the data signal DS or of the data element DE at the data device DG. As an alternative, the circuit is configured to provide the data element DE2 in the form of the data signal DS2 as a signal separate from the data signal DS1 at the data interface DAS.

As a result, it is ensured that the extension cable EK does not itself have to be connected to the data device DG via its own data interface DAS in order to transmit the data signal DS2 or the data element DE2 to the data device DG or to provide same to this data device DG, but rather that this task is carried out by the circuit ISK of the extension cable EK.

This is advantageous because a plurality of sensors SE, SE2 can thus be positioned at a patient P, without all respective extension cables EK, EK2 having to be connected to the data device DG by means of respective data interfaces DAS, but rather that it is sufficient to provide a separate extension cable EK, EK2 for each sensor SE, SE2, which extension cable generates a respective data signal DS, DS2 or a respective data element DE, DE2 by means of a respective circuit unit ISK, ISK2, so that then the final transmission of all data signals DS, DS2 or data elements DE, DE2 to the data device can take place via an individual data interface DAS of an individual extension cable EK.

While specific embodiments of the invention have been shown and described in detail to illustrate the application of the principles of the invention, it will be understood that the invention may be embodied otherwise without departing from such principles.

### APPENDIX

### LIST OF REFERENCE DESIGNATIONS

AD Analog/digital converter
ALD Alarm data
ALF Alarm event
ASS Data connection interface/Connection interface
AW1, AW2 Alarm limit value
AW1D, AW2D Alarm limit value data
AWE Acoustic output unit
AZ Display signal
AZS Display interface/display interface
DAS, DS1, DS1 Data interface
DE, DE2 Data element
DG Data network device
DS, DS2, DS3 Data signal
EK, EK2 Extension cable
ES, ES2 Electrical signal
FECD Redundant data
IN1, IN2 Data input interface
IND Information data
ISK, ISK2 Integrated circuit
KB, KB2 Contacting area
KS Contacting interface
LE Lighting element
MEM Memory unit
MW Measured value
MWD Measured value data
NW Network
OS Optical signal
OUT1, OUT2 Data output interface
P Patient
P11, P12, P21, P22 Circuit interface
PATID Patient identification data
PM Patient monitor
PR Processor unit
PRD Degree of priority data
SE, SE2 Sensor
SEK, SEK2 Sensor cable
T1, TAL, T2 Time value
TD Time data
TX Transmitter
TYPD Sensor identification data

1. A medical sensor extension cable comprising:
an electrical contacting interface configured to connect to a medical sensor and to receive an electrical sensor signal, which indicates a physiological parameter of a patient;
a wired data interface configured to connect to a data network device; and
an integrated circuit configured to process the sensor signal and configured:
to determine measured values of the physiological parameter based on the sensor signal;
to provide at least one alarm limit value in relation to the physiological parameter;
to establish a presence of an alarm event as a function of a comparison of the measured values and the at least one alarm limit value; and
to provide one or more data elements, which indicate the measured values and the presence of the alarm event in the event of an alarm via the data interface, by a data signal.

2. A medical sensor extension cable in accordance with claim 1, wherein the data elements further indicate the at least one alarm limit value.

3. A medical sensor extension cable in accordance with claim 1, wherein the data elements further indicate a degree of priority in relation to a prioritized transmission of the data elements in a data network.

4. A medical sensor extension cable in accordance with claim 1, wherein the data elements further indicate a physiological property corresponding to the measured values.

5. A medical sensor extension cable in accordance with claim 1, wherein the data elements further indicate at least one time value associated with the measured values.

6. A medical sensor extension cable in accordance with claim 1, wherein the data interface is an optical data interface.

7. A medical sensor extension cable in accordance with claim 6, wherein the data elements are provided by means of an optical data signal as the data signal.

8. A medical sensor extension cable in accordance with claim 6, wherein the integrated circuit is further configured to receive optical energy via the optical data interface.

9. A medical sensor extension cable in accordance with claim 1, wherein the integrated circuit is configured to store patient identification data and the data elements further indicate the patient identification data.

10. A medical sensor extension cable in accordance with claim 1, wherein the data elements further contain redundant data of an error-correcting code, which makes possible an error correction of data of the data elements.

11. A medical sensor extension cable in accordance with claim 1, wherein the data elements are provided in an encrypted form.

12. A medical sensor extension cable in accordance with claim 1, wherein the integrated circuit is configured to store sensor identification data, which indicate a model of the medical sensor, and the data elements indicate the sensor identification data.

13. A medical sensor extension cable in accordance with claim 1, wherein the data network device is a data router or a USB hub.

14. A data network device comprising:
a data connection interface for a data interface of a medical sensor extension cable comprising the data interface, an electrical contacting interface configured to connect to a medical sensor and to receive an electrical sensor signal, which indicates a physiological parameter of a patient and an integrated circuit configured to process the sensor signal and configured to determine measured values of the physiological parameter based on the sensor signal, to provide at least one alarm limit value in relation to the physiological parameter, to establish a presence of an alarm event as a function of a comparison of the measured values and the at least one alarm limit value and to provide one or more data elements, which indicate the measured values and the presence of the alarm event in the event of an alarm via the data interface, by a data signal, wherein the data connection interface is configured to receive the one data element or the plurality of data elements by means of the data signal; and
a display interface, wherein the data network device is configured to provide a display signal, which indicates the measured values and the alarm limits, via the display interface.

15. A data network device comprising:
a data connection interface for a data interface of a medical sensor extension cable comprising the data interface, an electrical contacting interface configured to connect to a medical sensor and to receive an electrical sensor signal, which indicates a physiological parameter of a patient and an integrated circuit configured to process the sensor signal and configured to determine measured values of the physiological parameter based on the sensor signal, to provide at least one alarm limit value in relation to the physiological parameter, to establish a presence of an alarm event as a function of a comparison of the measured values and the at least one alarm limit value and to provide one or more data elements, which indicate the measured values and the presence of the alarm event in the event of an alarm via the data interface, by a data signal, wherein the data connection interface is configured to receive the one data element or the plurality of data elements by means of the data signal and the one or more data elements further indicate the at least one alarm limit value; and
an additional data interface, wherein the data connection interface is configured to receive the one data element or the plurality of data elements by means of a data signal and the data network device is configured to transmit the data elements as a function of the degree of priority via the additional data interface.

16. A data network device in accordance with claim 15, wherein the additional data interface is an interface for connecting a patient monitor.

17. A data network device in accordance with claim 16, wherein the additional data interface is a first additional data interface, wherein the data network device further comprises a second additional data interface and the data network device is configured to transmit the data elements via the second additional data interface with a priority lower than via the first additional data interface.
